(19) United States
(12) Patent Application Publication
(10) Pub. No.: US 2017/0273137 A1
(43) Pub. Date: Sep. 21, 2017

(54) Method and Apparatus for Configuring Discontinuous Reception and Communication System

(71) Applicant: FUJITSU LIMITED, Kawasaki-shi (JP)

(72) Inventors: Lianhai WU, Beijing (CN); Haibo XU, Beijing (CN); Hua ZHOU, Beijing (CN)

(73) Assignee: FUJITSU LIMITED, Kawasaki-shi (JP)

(21) Appl. No.: 15/616,491

(22) Filed: Jun. 7, 2017

Related U.S. Application Data
(63) Continuation of application No. PCT/CN2014/093393, filed on Dec. 9, 2014.

(51) Int. Cl. H04W 76/04; H04W 72/04; H04W 48/12; H04W 64/00

(52) U.S. Cl. CPC H04W 76/048; H04W 64/003; H04W 72/0446; H04W 48/12; H04W 84/042

(57) ABSTRACT

A method and apparatus for configuring discontinuous reception, and a communication system. The method includes: a base station respectively configures DRX parameters for a first part of resources and a second part of resources; or, a user equipment is configured with a set of DRX parameters, and the priority of a proximity based service and a cellular service is configured in the user equipment. By means of the embodiments of the present disclosure, even when the user equipment has only one receiving device, the problem of a time conflict in simultaneous reception of such as PDCCH and ProSe data can be solved.

### CROSS REFERENCE TO RELATED APPLICATIONS

This application is a continuation application of International Application PCT/CN2014/093393 filed on Dec. 9, 2014, the entire contents of which are incorporated herein by reference.

### TECHNICAL FIELD

This disclosure relates to the field of communications, and in particular to a method and apparatus for configuring discontinuous reception (DRX), and a communication system.

### BACKGROUND

A proximity-based service (ProSe), which may also be referred to as a device to device (D2D) service, is widely studied at present. ProSe communication refers to a communication manner in which communication of data packets is performed via a communication link directly established between user equipment (UE), such as UE 1 and UE 2, without via a core network and a base station (such as an eNB). Before the ProSe communication is performed, ProSe discovery process is usually performed. For example, before UE 1 transmits information to UE 2 in the ProSe communication manner, it needs first to discover whether UE 2 is in proximity.

FIG. 1 is a schematic diagram of ProSe discovery or ProSe communication in the prior art, in which a case where ProSe discovery is performed or ProSe communication is established by two pieces of UE (such as UE 1 and UE 2) belonging to the same base station is shown. FIG. 2 is another schematic diagram of ProSe discovery or ProSe communication in the prior art, in which a case where ProSe discovery is performed or ProSe communication is established by two pieces of UE belonging to different base stations (such as eNB 1 and eNB 2) is shown.

For the ProSe discovery process of the UE, when the UE is triggered to start the discovery process (such as transmitting a discovery signal or receiving a discovery signal), the UE will inform the base staion that it will perform ProSe discovery and require for allocation of ProSe discovery resources. After receiving the request from the UE, the base station will configure the UE with ProSe discovery resources. The base station may possibly configure the UE with ProSe discovery resources via dedicated signaling, or may also possibly notify the UE of directly using ProSe discovery resources broadcast by a system information block (SIB).

Likewise, when the UE is triggered for the need to perform ProSe communication, the UE will inform the base station that it will perform ProSe communication and require allocation of ProSe communication resources. After receiving the request from the UE, the base station will configure the UE with ProSe communication resources. The base station may possibly configure the UE with ProSe communication resources via dedicated signaling, or may also possibly notify the UE of directly using ProSe communication resources broadcast by an SIB.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Currently, resource pools used for ProSe discovery or communication are divided into two parts. Part I resources may include ProSe resources (ProSe discovery resources and/or ProSe communication resources), and may further include cellular communication resources; and part II resources only include cellular communication resources, and do not include ProSe resources.

However, it was found by the inventors that in existing technical solutions, when UE has only one receiving device, the UE will possibly need to receive physical downlink control channels (PDCCHs) and ProSe data at the same time, thereby causing a problem of time conflict.

Embodiments of this disclosure provide a method and apparatus for configuring discontinuous reception (DRX), and a communication system, in which when UE has only one receiving device, a problem of time conflict is solved by configuring DRX parameters.

According to a first aspect of the embodiments of this disclosure, there is provided a method for configuring discontinuous reception, including:
configuring DRX parameters respectively for part I resources and part II resources of UE by a base station; the part I resources include resources of a proximity-based service and resources of a cellular service, and the part II resources include resources of a cellular service; or
configuring a set of DRX parameters for the UE, and configuring priorities of a proximity-based service and a cellular service for the UE.

According to a second aspect of the embodiments of this disclosure, there is provided an apparatus for configuring discontinuous reception, configured in a base station, the apparatus including:
a resource configuring unit configured to configure DRX parameters respectively for part I resources and part II resources of UE; the part I resources include resources of a proximity-based service and resources of a cellular service, and the part II resources include resources of a cellular service; or
configured to configure a set of DRX parameters for the UE, and configure priorities of a proximity-based service and a cellular service for the UE.

According to a third aspect of the embodiments of this disclosure, there is provided a method for configuring discontinuous reception, including:
performing information detection by UE according to DRX parameters and resources configured by a base station; part I resources and part II resources of the UE are respectively configured with DRX parameters, the part I resources including resources of a proximity-based service and resources of a cellular service, and the part II resources including resources of a cellular service.

According to a fourth aspect of the embodiments of this disclosure, there is provided an apparatus for configuring DRX, configured in UE, the apparatus including:
a detecting unit configured to perform information detection according to DRX parameters and resources configured by a base station; part I resources and part II resources of the UE are respectively configured with DRX parameters, the part I resources including resources of a proximity-based service and resources of a cellular service, and the part II resources including resources of a cellular service.

According to a fifth aspect of the embodiments of this disclosure, there is provided a method for configuring discontinuous reception, including:
performing information detection by UE according to DRX parameters and resources configured by a base station; the UE is configured with a set of DRX parameters, and priorities of a proximity-based service and a cellular service are configured in the UE.

According to a sixth aspect of the embodiments of this disclosure, there is provided an apparatus for configuring DRX, configured in UE, the apparatus including:
a detecting unit configured to perform information detection according to DRX parameters and resources configured by a base station; the UE is configured with a set of DRX parameters, and priorities of a proximity-based service and a cellular service are configured in the UE.

According to a seventh aspect of the embodiments of this disclosure, there is provided a communication system, including:
a base station configured to configure DRX parameters respectively for part I resources and part II resources of UE; the part I resources includes resources of a proximity-based service and resources of a cellular service, and the part II resources includes resources of a cellular service; and

UE configured to perform information detection according to the DRX parameters and resources configured by the base station.

According to an eighth aspect of the embodiments of this disclosure, there is provided a communication system, including:

UE configured to perform information detection according to DRX parameters and resources configured by a base station; the UE is configured with a set of DRX parameters, and priorities of a proximity-based service and a cellular service are configured in the UE.

According to another aspect of the embodiments of this disclosure, there is provided a computer readable program code, which, when executed in a base station, will cause a computer unit to carry out the method for configuring discontinuous reception as described above in the base station.

According to a further aspect of the embodiments of this disclosure, there is provided a computer readable medium, including a computer readable program code, which will cause a computer unit to carry out the method for configuring discontinuous reception as described above in a base station.

According to still another aspect of the embodiments of this disclosure, there is provided a computer readable program code, which, when executed in UE, will cause a computer unit to carry out the method for configuring discontinuous reception as described above in the UE.

According to a further aspect of the embodiments of this disclosure, there is provided a computer readable medium, including a computer readable program code, which will cause a computer unit to carry out the method for configuring discontinuous reception as described above in UE.

An advantage of the embodiments of this disclosure exists in that by configuring the part I resources and the part II resources respectively with DRX parameters, or by configuring the UE with priorities of a ProSe service and a cellular service, even when UE has only one receiving device, the problem of a time conflict in simultaneous reception of such as PDCCH and ProSe data can be solved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of ProSe discovery or ProSe communication in the prior art;

FIG. 2 is another schematic diagram of ProSe discovery or ProSe communication in the prior art;

FIG. 3 is a schematic diagram of configuration of a resource pool for ProSe discovery or ProSe communication;

FIG. 4 is a flowchart of the method for configuring DRX of Embodiment 1 of this disclosure;

FIG. 5 is another flowchart of the method for configuring DRX of Embodiment 1 of this disclosure;

FIG. 6 is a flowchart of the method for configuring DRX of Embodiment 2 of this disclosure;

FIG. 7 is another flowchart of the method for configuring DRX of Embodiment 2 of this disclosure;

FIG. 8 is a schematic diagram of the apparatus for configuring DRX of Embodiment 3 of this disclosure;

FIG. 9 is a schematic diagram of a structure of the base station of Embodiment 3 of this disclosure;

FIG. 10 is another schematic diagram of the apparatus for configuring DRX of Embodiment 3 of this disclosure;

FIG. 11 is a schematic diagram of a structure of the UE of Embodiment 3 of this disclosure;

FIG. 12 is a schematic diagram of the apparatus for configuring DRX of Embodiment 4 of this disclosure;

FIG. 13 is another schematic diagram of the apparatus for configuring DRX of Embodiment 4 of this disclosure; and

FIG. 14 is a schematic diagram of a structure of the communication system of Embodiment 5 of this disclosure.

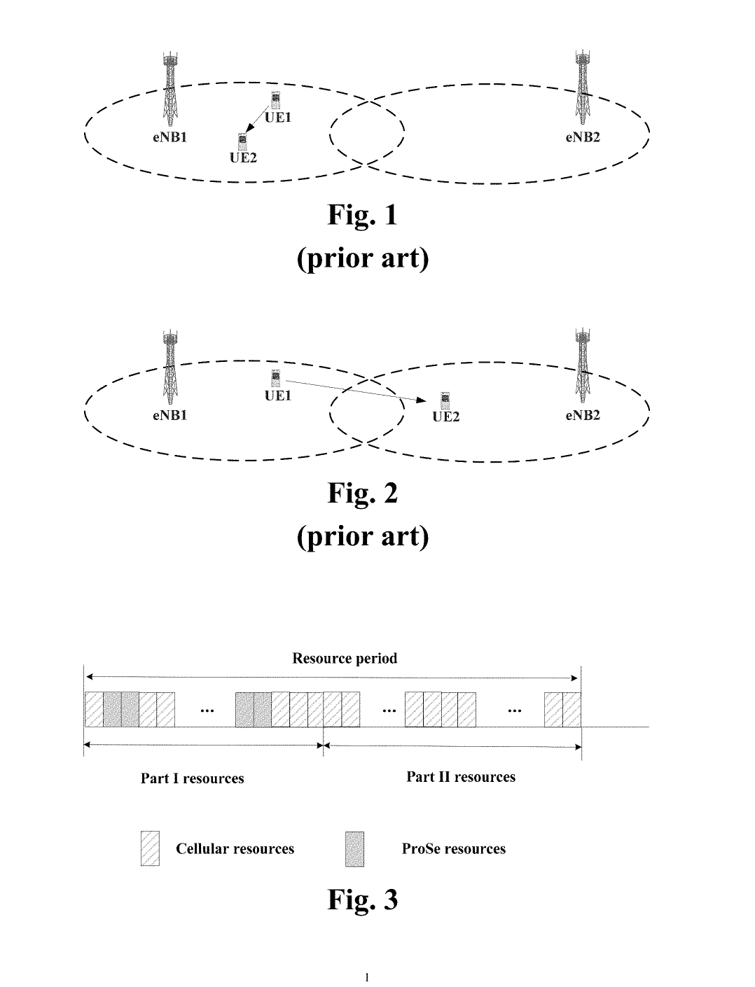

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

FIG. 3 is a schematic diagram of configuration of a resource pool for ProSe discovery or ProSe communication. As shown in FIG. 3, resources in the resource pool may be divided into two parts. Part I resources may include ProSe discovery resources and/or ProSe communication resources (that is, proximity-based service resources, which may be referred to as ProSe resources), and may further include conventional cellular service resources (which may be referred to as cellular resources); and part II resources only include cellular resources, and do not include ProSe resources.

On the other hand, a configuration method of discontinuous reception (DRX) based on a long-term evolution (LTE) system is defined by 3^{rd} generation partnership project (3GPP). In the DRX mechanism of the LTE, when uplink data has arrived in UE, if it is needed to trigger a scheduling request or random access, the UE will trigger the scheduling request or random access immediately, and then stop a sleep state to enter an activated state to monitor PDCCHs of a base station. For example, the DRX may be controlled by an inactivity timer and/or a retransmission timer, and the relevant art may be referred to for the DRX mechanism.

The embodiments of this disclosure shall be described below in detail.

### Embodiment 1

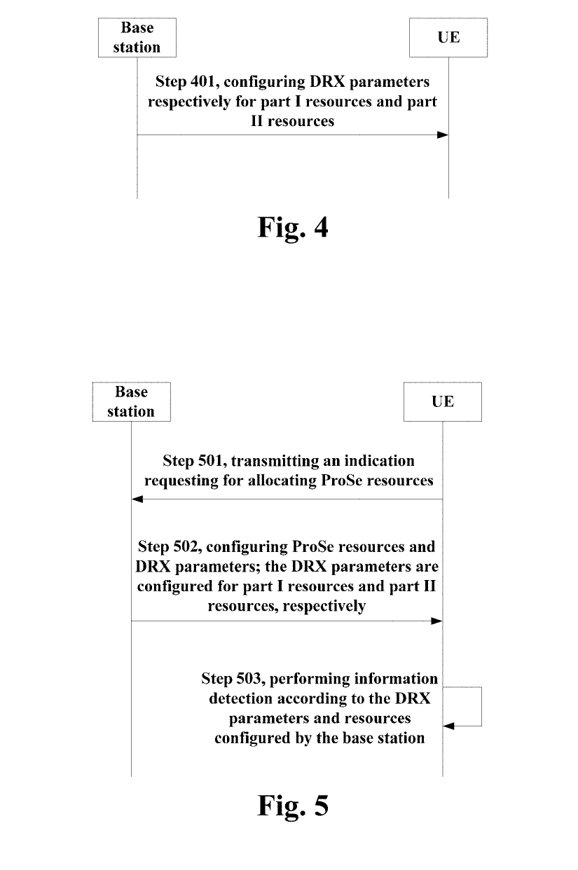

An embodiment of this disclosure provides a method for configuring discontinuous reception. FIG. 4 is a flowchart of the method for configuring DRX of the embodiment of this disclosure. As shown in FIG. 4, the method includes:

Step 401: a base station configures DRX parameters respectively for part I resources and part II resources of UE. The part I resources include ProSe resources and resources of a cellular service, and the part II resources include resources of a cellular service.

For example, the part II resources do not include ProSe resources, that is, the part I resources include ProSe resources and cellular resources, and the part II resources include cellular resources, and do not include ProSe resources.

In this embodiment, the base station may configure the part I resources and the part II resources respectively with a set of independent DRX parameters. In particular, a set of DRX parameters are dedicated for the part I resources, and the other set of DRX parameters are dedicated for the part II resources.

When the UE changes from using the part I resources into using the part II resources, the use of the DRX parameters dedicated for the part I resources is stopped, and the use of the other set of DRX parameters begins. And when the UE changes from using the part II resources into using the part I resources, the use of the DRX parameters dedicated for the part II resources is stopped, and the use of the other set of DRX parameters begins.

In this embodiment, the proximity-based service includes ProSe discovery and/or ProSe communication.

FIG. 5 is another flowchart of the method for configuring DRX of the embodiment of this disclosure, in which the base station and the UE are shown. As shown in FIG. 5, the method includes:

Step 501: the UE transmits to the base station an indication requesting for allocating ProSe resources.

In this embodiment, if the ProSe UE is interested in ProSe discovery (or ProSe communication), it will transmit the indication to the base station.

Step 502: the base station configures the UE with ProSe resources and DRX parameters, in which, the DRX parameters are configured for the part I resources and the part II resources, respectively.

In this embodiment, once the base station receives the indication, it will configure the UE with ProSe discovery resources (or ProSe communication resources) and DRX parameters.

For example, a set 1 of DRX parameters are configured for the part I resources of the UE, and a set 2 of DRX parameters are configured for the part II resources of the UE; hence, the UE has two sets of DRX parameters.

Step 503: the UE performs information detection according to the DRX parameters and resources configured by the base station.

For example, when the UE changes from using the part I resources into using the part II resources, the use of the DRX parameters of the part I resources is stopped, and the use of the DRX parameters of the part II resources begins; and when the UE changes from using the part II resources into using the part I resources, the use of the DRX parameters of the part II resources is stopped, and the use of the DRX parameters of the part I resources begins.

In this embodiment, the information detection by the UE may include PDCCH detection and/or ProSe data reception.

It can be seen from the above embodiment that by configuring the part I resources and the part II resources respectively with DRX parameters, time for receiving the PDCCHs and the ProSe data may be staggered, even when UE has only one receiving device, the problem of a time conflict in simultaneous reception of such as PDCCH and ProSe data can be solved.

### Embodiment 2

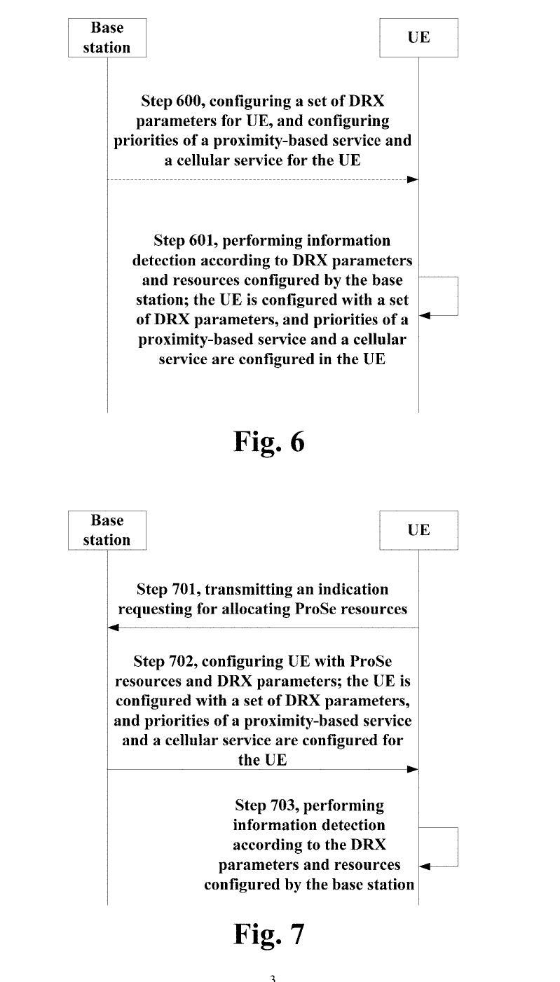

An embodiment of this disclosure provides a method for configuring discontinuous reception. FIG. 6 is a flowchart of the method for configuring DRX of the embodiment of this disclosure. As shown in FIG. 6, the method includes:

Step 601: UE performs information detection according to DRX parameters and resources configured by a base station. The UE is configured with a set of DRX parameters, and priorities of a proximity-based service and a cellular service are configured in the UE.

For example, when a clock of an inactivity timer and/or a retransmission timer operates, the UE receives data according to the priorities of the proximity-based service and the cellular service.

For example, when the priority of the proximity-based service is higher than that of the cellular service, the UE preferentially receives data of the proximity-based service, and when the priority of the cellular service is higher than that of the proximity-based service, the UE preferentially receives data of the cellular service.

In this embodiment, the information detection may include PDCCH detection and/or ProSe data reception.

In this embodiment, the UE may be preconfigured with the priorities of the proximity-based service and the cellular service; for example, it may be preset that the priority of the proximity-based service is higher than that of the cellular service in the UE. Furthermore, the priorities of the proximity-based service and the cellular service may also be configured by the base station; for example, they may be configured dynamically, that is, in a period of time, the priority of the proximity-based service is higher than that of the cellular service in the UE, and in another period of time, the priority of the cellular service is higher than that of the proximity-based service in the UE; however, this disclosure is not limited thereto. Following description is given taking configuration by the base station as an example.

As shown in FIG. 6, the method may further include:

Step 600: the base station configures a set of DRX parameters for the UE, and configures priorities of a proximity-based service and a cellular service for the UE.

In this embodiment, the base station may configure the UE with a set of DRX parameters. When the clock of the inactivity timer and/or the retransmission timer operates, the UE may perform reception according to the priorities of the cellular service and the ProSe service.

For example, the base station may configure that the priority of the proximity-based service is higher than that of the cellular service, and when the clock of the inactivity timer and/or the retransmission timer operates, the UE preferentially receives the ProSe data. Or, the base station may configure that the priority of the cellular service is higher than that of the proximity-based service, and when the clock of the inactivity timer and/or the retransmission timer operates, the UE preferentially receives the cellular data.

In this embodiment, the proximity-based service may include ProSe discovery and/or ProSe communication.

FIG. 7 is another flowchart of the method for configuring DRX of the embodiment of this disclosure, in which the base station and the UE are shown. As shown in FIG. 7, the method includes:

Step 701: UE transmits an indication requesting for allocating ProSe resources.

In this embodiment, when the ProSe UE is interested in ProSe discovery (or ProSe communication), it will transmit the indication to the base station.

Step 702: the base station configures the UE with ProSe resources and DRX parameters. The UE is configured with a set of DRX parameters, and priorities of a proximity-based service and a cellular service are configured for the UE.

In this embodiment, once the base station receives the indication, it will configure the UE with ProSe discovery resources (or ProSe communication resources) and DRX parameters.

Step 703: the UE performs information detection according to the DRX parameters and resources configured by the base station.

For example, when the clock of the inactivity timer and/or the retransmission timer operates, the UE receives the data according to the priorities of the proximity-based service and the cellular service.

In this embodiment, the information detection by the UE may include PDCCH detection and/or ProSe data reception.

It can be seen from the above embodiment that by configuring the UE with the priorities of the proximity-based service and the cellular service, the PDCCHs or the ProSe data may be received according to the priorities, even when UE has only one receiving device, the problem of a time conflict in simultaneous reception of such as PDCCH and ProSe data can be solved.

### Embodiment 3

An embodiment of this disclosure provides an apparatus for configuring discontinuous reception, which corresponds to the method for configuring discontinuous reception of Embodiment 1, with identical contents being not going to be described herein any further.

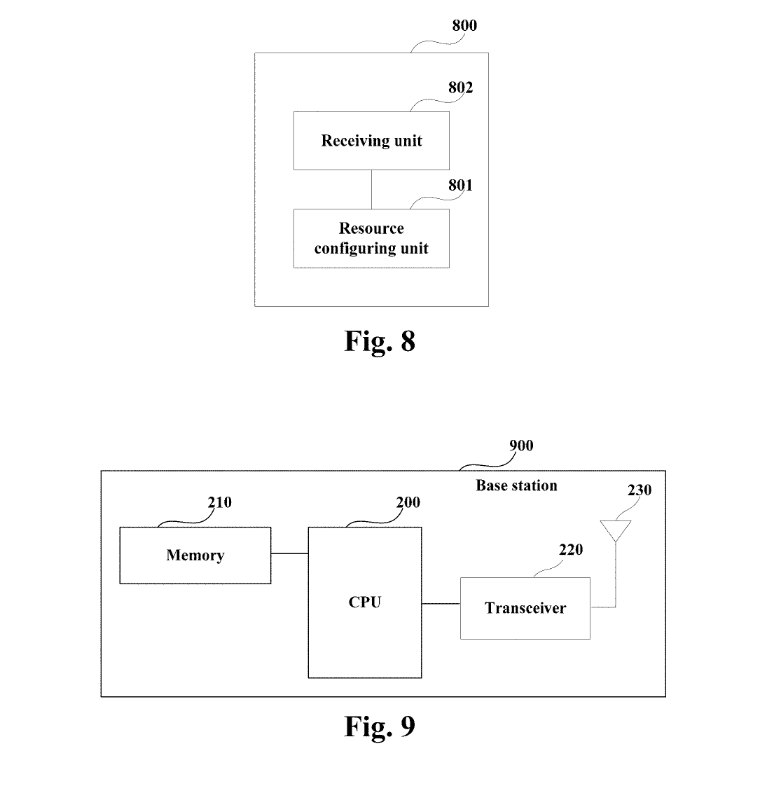

FIG. 8 is a schematic diagram of the apparatus for configuring discontinuous reception of the embodiment of this disclosure, which may be configured in a base station. As shown in FIG. 8, the apparatus 800 for configuring discontinuous reception includes:
a resource configuring unit 801 configured to configure DRX parameters respectively for part I resources and part II resources of user equipment (UE). The part I resources comprise resources of a proximity-based service and resources of a cellular service, and the part II resources comprise resources of a cellular service.

For example, the part II resources do not include ProSe resources, and the proximity-based service includes proximity-based service discovery and/or proximity-based service communication.

As shown in FIG. 8, the apparatus 800 for configuring discontinuous reception may further include:
a receiving unit 802 configured to receive an indication transmitted by the UE requesting for allocating resources of the proximity-based service.

In this embodiment, after the receiving unit 802 receives the indication transmitted by the UE, the resource configuring unit 801 may configure the UE with the ProSe resources and DRX parameters. For example, DRX parameters are respectively configured for the part I resources and the part II resources.

The embodiment of this disclosure further provides a base station, configured with the above-described apparatus 800 for configuring discontinuous reception.

FIG. 9 is a schematic diagram of a structure of the base station of the embodiment of this disclosure. As shown in FIG. 9, the base station 900 may include a central processing unit (CPU) 200 and a memory 210, the memory 210 being coupled to the central processing unit 200. The memory 210 may store various data, and furthermore, it may store a program for information processing, and execute the program under control of the central processing unit 200, so as to receive various information transmitted by the UE, and transmit request information to the UE.

The central processing unit 200 may be configured to carry out the functions of the apparatus 800 for configuring discontinuous reception. The base station 900 may carry out the method described in Embodiment 1 corresponding to a base station side.

Furthermore, as shown in FIG. 9, the base station 900 may include a transceiver 220, and an antenna 230, etc. Functions of the above components are similar to those in the relevant art, and shall not be described herein any further. It should be noted that the base station 900 does not necessarily include all the parts shown in FIG. 9, and furthermore, the base station 900 may include parts not shown in FIG. 9, and the relevant art may be referred to.

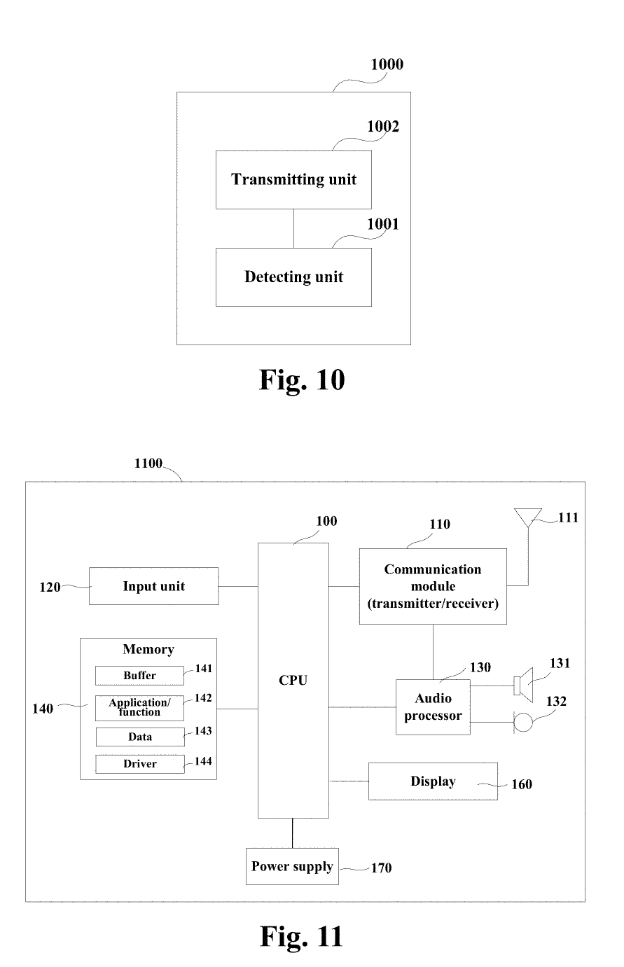

FIG. 10 is a schematic diagram of the apparatus 1000 for configuring discontinuous reception of the embodiment of this disclosure, which may be configured in UE. As shown in FIG. 10, the apparatus 1000 for configuring discontinuous reception includes:
a detecting unit 1001 configured to perform information detection according to DRX parameters and resources configured by a base station.

For example, part I resources and part II resources of the UE are respectively configured with DRX parameters, the part I resources including resources of a proximity-based service and resources of a cellular service, and the part II resources including resources of a cellular service. Furthermore, the part II resources do not include ProSe resources.

As shown in FIG. 10, the apparatus 1000 for configuring discontinuous reception may further include:
a transmitting unit 1002 configured to transmit to the base station an indication requesting for allocating resources of the proximity-based service.

For example, when the UE changes from using the part I resources into using the part II resources, the detecting unit 1001 is configured to stop using the DRX parameters of the part I resources, and begin to use the DRX parameters of the part II resources; and when the UE changes from using the part II resources into using the part I resources, the detecting unit 1001 is configured to stop using the DRX parameters of the part II resources, and begin to use the DRX parameters of the part I resources.

In this embodiment, when the UE is interested in ProSe discovery or ProSe communication, the transmitting unit 1002 is configured to transmit the indication requesting for allocating resources of the proximity-based service to the base station. After the base station configures the UE with the ProSe resources and the DRX parameters, the detecting unit 1001 may be configured to perform information detection according to the DRX parameters and resources configured by the base station, such as PDCCH detection and/or ProSe data reception.

The embodiment of this disclosure further provides UE, configured with the above-described apparatus 1000 for configuring discontinuous reception.

FIG. 11 is a schematic diagram of a systematic structure of the UE of the embodiment of this disclosure. As shown in FIG. 11, the UE 1100 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the apparatus 1000 for configuring discontinuous reception may be integrated into the central processing unit 100. The central processing unit 100 may be configured to carry out the method described in Embodiment 1 corresponding to UE side.

In another implementation, the apparatus 1000 for configuring discontinuous reception and the central processing unit 100 may be configured separately. For example, the apparatus 1000 for configuring discontinuous reception may be configured as a chip connected to the central processing unit 100, with its functions being realized under control of the central processing unit 100.

As shown in FIG. 11, the UE 1100 may further include a communication module 110, an input unit 120, an audio processor 130, a display 160 and a power supply 170. It should be noted that the UE 1100 does not necessarily include all the parts shown in FIG. 11, and furthermore, the UE 1100 may include parts not shown in FIG. 11, and the relevant art may be referred to.

As shown in FIG. 11, the central processing unit 100 is sometimes referred to as a controller or control element, and may include a microprocessor or other processor devices and/or logic devices. The central processing unit 100 may receive input and control operations of every components of the UE 1100.

The memory 140 may be, for example, one or more of a buffer memory, a flash memory, a hard drive, a mobile medium, a volatile memory, a nonvolatile memory, or other suitable devices, which may store the above planned network information and deployed network information, and may further store a program executing related information. And the central processing unit 100 may execute the program stored in the memory 140, so as to realize information storage or processing, etc. Functions of other parts are similar to those of the relevant art, which shall not be described herein any further. The parts of the UE 1100 may be realized by specific hardware, firmware, software, or any combination thereof, without departing from the scope of the present disclosure.

It can be seen from the above embodiment that by configuring the part I resources and the part II resources respectively with DRX parameters, time for receiving the PDCCHs and the ProSe data may be staggered, even when UE has only one receiving device, the problem of a time conflict in simultaneous reception of such as PDCCH and ProSe data can be solved.

### Embodiment 4

An embodiment of this disclosure provides an apparatus for configuring discontinuous reception, which corresponds to the method for configuring discontinuous reception of Embodiment 2, with identical contents being not going to be described herein any further.

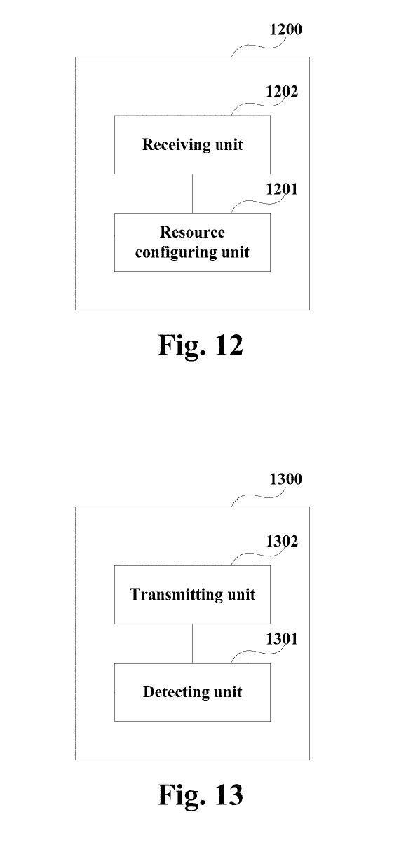

FIG. 12 is a schematic diagram of the apparatus 1200 for configuring discontinuous reception of the embodiment of this disclosure, which may be configured in a base station. As shown in FIG. 12, the apparatus 1200 for configuring discontinuous reception includes:
a resource configuring unit 1201 configured to configure a set of DRX parameters for the UE, and configure priorities of a proximity-based service and a cellular service for the UE.

As shown in FIG. 12, the apparatus 1200 may further include:
a receiving unit 1202 configured to receive an indication transmitted by the UE requesting for allocating resources of the proximity-based service.

In this embodiment, after the receiving unit 1202 receives the indication transmitted by the UE, the resource configuring unit 1201 may configure the UE with ProSe resources and DRX parameters.

Furthermore, the UE is configured with a set of DRX parameters, and priorities of a proximity-based service and a cellular service are configured in the UE. The priorities of a proximity-based service and a cellular service may be configured by the resource configuring unit 1201, or may also be pre-configured.

The embodiment of this disclosure further provides a base station, configured with the above-described apparatus 1200 for configuring discontinuous reception. FIG. 9 in Embodiment 3 may be referred to for a particular structure of the base station. For example, a central processing unit 200 of the base station may be configured to carry out the method corresponding to the base station side described in Embodiment 2.

FIG. 13 is another schematic diagram of the apparatus for configuring discontinuous reception of the embodiment of this disclosure, which is configured in UE. As shown in FIG. 13, the apparatus 1300 for configuring discontinuous reception includes:
a detecting unit 1301 configured to perform information detection according to DRX parameters and resources configured by a base station; the UE is configured with a set of DRX parameters, and priorities of a proximity-based service and a cellular service are configured in the UE;

In this embodiment, when a clock of an inactivity timer and/or a retransmission timer operates, the detecting unit 1301 may be configured to receive data according to the priorities of the proximity-based service and the cellular service. For example, when the priority of the proximity-based service is higher than that of the cellular service, the detecting unit 1301 may be configured to preferentially receive data of the proximity-based service, and when the priority of the cellular service is higher than that of the proximity-based service, the detecting unit 1301 may be configured to preferentially receive data of the cellular service.

As shown in FIG. 13, the apparatus 1300 for configuring discontinuous reception may further include:
a transmitting unit 1302 configured to transmit to the base station indication requesting for allocating resources of the proximity-based service.

In this embodiment, when the UE is interested in ProSe discovery or ProSe communication, the transmitting unit 1302 may be configured to transmit to the base station the indication requesting for allocating resources of the proximity-based service. After the base station configures the UE with the ProSe resources and the DRX parameters, the detecting unit 1301 may be configured to perform information detection according to the DRX parameters and resources configured by the base station, such as PDCCH detection and/or ProSe data reception.

The embodiment of this disclosure further provides UE, configured with the above-described apparatus 1300 for configuring discontinuous reception, FIG. 11 in Embodiment 3 being able to be referred to for a particular structure of the UE. For example, a central processing unit 100 of the UE may be configured to carry out the method corresponding to the UE side described in Embodiment 1.

It can be seen from the above embodiment that by configuring the UE with the priorities of the proximity-based service and the cellular service, the PDCCHs or the ProSe data may be received according to the priorities, even when UE has only one receiving device, the problem of a time conflict in simultaneous reception of such as PDCCH and ProSe data can be solved.

### Embodiment 5

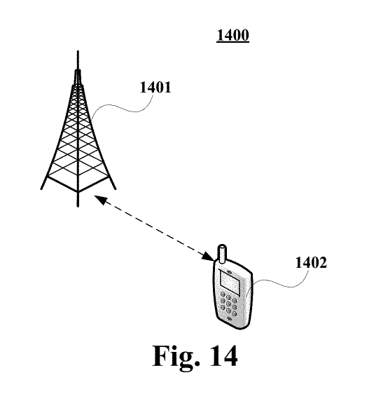

An embodiment of this disclosure provides a communication system. FIG. 14 is a schematic diagram of a structure of the communication system of the embodiment of this disclosure. As shown in FIG. 14, the communication system 1400 includes a base station 1401 and UE 1402.

In an implementation, the base station 1401 configures DRX parameters respectively for part I resources and part II resources of the UE. The part I resources include resources of a proximity-based service and resources of a cellular service, and the part II resources include resources of a cellular service. The UE 1402 is configured to perform information detection according to the DRX parameters and resources configured by the base station.

For example, when the UE 1402 changes from using the part I resources into using the part II resources, the use of the DRX parameters of the part I resources is stopped, and the use of the DRX parameters of the part II resources is begun; or when the UE 1402 changes from using the part II resources into using the part I resources, the use of the DRX parameters of the part II resources is stopped, and the use of the DRX parameters of the part I resources is begun.

In another implementation, the UE 1402 performs information detection according to the DRX parameters and resources configured by the base station 1401; for example, when a clock of an inactivity timer and/or a retransmission timer operates, the UE 1402 is configured to receive data according to the priorities of the proximity-based service and the cellular service.

For example, the UE 1402 is configured with a set of DRX parameters, and priorities of a proximity-based service and a cellular service are configured in the UE 1402. And the base station 1401 may further configure the UE 1402 with a set of DRX parameters, and configure priorities of a proximity-based service and a cellular service for the UE.

An embodiment of the present disclosure provides a computer readable program, which, when executed in a base station, will cause a computer unit to carry out the method for configuring discontinuous reception described in Embodiment 1 or 2 in the base station.

An embodiment of the present disclosure provides a computer readable medium, including a computer readable program, which will cause a computer unit to carry out the method for configuring discontinuous reception described in Embodiment 1 or 2 in a base station.

An embodiment of the present disclosure provides a computer readable program, which, when executed in UE, will cause a computer unit to carry out the method for configuring discontinuous reception described in Embodiment 1 or 2 in the UE.

An embodiment of the present disclosure provides a computer readable medium, including a computer readable program, which will cause a computer unit to carry out the method for configuring discontinuous reception described in Embodiment 1 or 2 in UE.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for configuring discontinuous reception (DRX), configured in a base station, the apparatus comprising:
a resource configuring unit configured to configure DRX parameters respectively for part I resources and part II resources of user equipment (UE); wherein, the part I resources comprise resources of a proximity-based service and resources of a cellular service, and the part II resources comprise resources of a cellular service; or
configured to configure a set of DRX parameters for the UE, and configure priorities of a proximity-based service and a cellular service for the UE.

2. The apparatus according to claim 1, wherein the proximity-based service comprises proximity-based service discovery and/or proximity-based service communication.

3. The apparatus according to claim 1, wherein the apparatus further comprises:
a receiving unit configured to receive an indication transmitted by the UE requesting for allocating resources of the proximity-based service.

4. An apparatus for configuring DRX, configured in UE, the apparatus comprising:
a detecting unit configured to perform information detection according to DRX parameters and resources configured by a base station;
wherein, part I resources and part II resources of the UE are respectively configured with DRX parameters, the part I resources comprising resources of a proximity-based service and resources of a cellular service, and the part II resources comprising resources of a cellular service.

5. The apparatus according to claim 4, wherein the apparatus further comprises:
a transmitting unit configured to transmit to the base station an indication requesting for allocating resources of the proximity-based service.

6. The apparatus according to claim 4, wherein when the UE changes from using the part I resources into using the part II resources, the detecting unit is configured to stop using the DRX parameters of the part I resources, and begin to use the DRX parameters of the part II resources;
and when the UE changes from using the part II resources into using the part I resources, the detecting unit is configured to stop using the DRX parameters of the part II resources, and begin to use the DRX parameters of the part I resources.

7. The apparatus according to claim 4, wherein the information detection comprises: detection of a physical downlink control channel and/or reception of proximity-based service data.

8. An apparatus for configuring DRX, configured in UE, the apparatus comprising:
a detecting unit configured to perform information detection according to DRX parameters and resources configured by a base station;
wherein, the UE is configured with a set of DRX parameters, and priorities of a proximity-based service and a cellular service are configured in the UE.

9. The apparatus according to claim 8, wherein when a clock of an inactivity timer and/or a retransmission timer operates, the detecting unit is configured to receive data according to the priorities of the proximity-based service and the cellular service.

10. The apparatus according to claim 9, wherein when the priority of the proximity-based service is higher than that of the cellular service, the detecting unit is configured to receive data of the proximity-based service; and when the priority of the cellular service is higher than that of the proximity-based service, the detecting unit is configured to receive data of the cellular service.

11. The apparatus according to claim 8, wherein the information detection comprises: detection of a physical downlink control channel and/or reception of proximity-based service data.

12. A communication system, comprising:
a base station configured to configure DRX parameters respectively for part I resources and part II resources of UE; wherein, the part I resources comprise resources of a proximity-based service and resources of a cellular service, and the part II resources comprise resources of a cellular service; and
UE configured to perform information detection according to the DRX parameters and resources configured by the base station.

13. The communication system according to claim 12, wherein when the UE changes from using the part I resources into using the part II resources, the use of the DRX parameters of the part I resources is stopped, and the use of the DRX parameters of the part II resources is begun; or
when the UE changes from using the part II resources into using the part I resources, the use of the DRX parameters of the part II resources is stopped, and the use of the DRX parameters of the part I resources is begun.

14. A communication system, comprising:
UE configured to perform information detection according to DRX parameters and resources configured by a base station; wherein, the UE is configured with a set of DRX parameters, and priorities of a proximity-based service and a cellular service are configured in the UE.

15. The communication system according to claim 14, wherein when a clock of an inactivity timer and/or a retransmission timer operates, the UE is configured to receive data according to the priorities of the proximity-based service and the cellular service.

16. The communication system according to claim 14, wherein the communication system further comprises:
a base station configured to configure a set of DRX parameters for the UE, and configure the priorities of the proximity-based service and the cellular service for the UE.
